(19) United States
(12) Patent Application Publication
(10) Pub. No.: US 2004/0086094 A1
(43) Pub. Date: May 6, 2004

(54) Method of providing personal event notification during call setup

(76) Inventors: Barry S. Bosik, Marlboro, NJ (US); James C. Ehlinger, Colts Neck, NJ (US); Gary A. Munson, Little Silver, NJ (US)

Correspondence Address: AT&T CORP., P.O. BOX 4110, MIDDLETOWN, NJ, 07748, US

(21) Appl. No.: 10/289,110

(22) Filed: Nov. 6, 2002

(51) Int. Cl. H04M 1/64; H04M 11/00

(52) U.S. Cl. 379/88.12; 379/201.01; 379/88.18

(57) ABSTRACT

The present invention is directed to a method of notifying a caller of personal event information during the set-up of a call between the caller and a called party. A query is received from a communication network carrying the call from the caller to determine if the caller is a subscriber to a notification service. If the caller is a subscriber, a Notification and Management System (NMS) is queried to determine if the caller has any pending notifications pertaining to personal event information. If the caller has pending notifications, the call is temporarily sent to an announcement system. The pending notifications are played to the caller during call set-up. The communication network is instructed to continue to route the call to the called party.

### FIELD OF THE INVENTION

The present invention is directed to a method of providing notification of personal events during call setup, and more particularly, to a method of providing personal event messages originating from multiple sources to a notification processor via a data network which are communicated to a caller during call setup.

### BACKGROUND OF THE INVENTION

Many systems exist for providing a caller with information while the caller is in the process of or has already placed a call. Some systems provide the caller with advertising information. This information can be provided during call setup and, in many instances, a discount is accorded to the user for the call as a result of listening to the advertisements.

In many instances, the customer provides the system with a profile so that the advertisements can be tailored to the caller's interests or perceived interests. As such, it is believed that advertisements can be targeted to an appropriate audience and generate more sales. Furthermore, these advertisement systems usually require some interaction between the caller and the system to verify that the caller is actually listening to the advertisement.

Other systems exist which provide the caller with notification of email or voice mail messages either during call setup or during the call. The caller can then access their email or voice mail account to retrieve the messages. Other systems exist for playing email messages over the telecommunications network. However, these systems require the placement of special calls to an email service so that the messages can be read to the caller using text-to-speech technology.

Systems also exist which provide the caller with information of interest during call set up. Some systems provide information to the caller about the location of the called party. For example, weather information or time could be provided to the caller relating to the geographical location of the called party. However, in these instances the system and not the caller determine the information of interest.

There is a need for a notification system in which the caller can receive notification of personal events pertaining to the caller, and furthermore, where the personal event information can originate from multiple information sources and be managed by the caller.

### SUMMARY OF THE INVENTION

The present invention is directed to a method of notifying a caller of personal event information during the set-up of a call between the caller and a called party. A query is received at a service processor from a communication network carrying the call from the caller to determine if the caller is a subscriber to a notification service. If the caller is a subscriber, a Notification and Management System (NMS) is queried to determine if the caller has any pending notifications pertaining to personal event information. The pending notifications originate from sources external to the communication network, such as the user's email account, voice mail account or a user's personal calendar software. If the caller has pending notifications, the call is temporarily sent to an announcement system. The pending notifications are played to the caller during call set-up. The communication network is instructed to continue to route the call to the called party.

The caller can manage the type of events and content about which to be notified through a feature management system. Events may be detected at a variety of networked sources that are screened by an event detection system. The event detection system reports those events that are determined to be relevant to the NMS.

### BRIEF DESCRIPTION OF THE DRAWINGS

The present invention is illustrated by way of example and not limitation in the accompanying figures in which reference numerals indicate similar elements and in which:

FIG. 1 illustrates a block diagram of a network architecture that implements the present invention;

FIGS. 2A-2C illustrate a flow chart depicting the steps for new and existing users to update an event notification profile in accordance with the present invention;

FIGS. 3A and 3B are a flow chart depicting the steps for detecting an event notification in accordance with the present invention;

FIG. 4 is a flow chart depicting the steps for receiving event notifications during call set-up in accordance with the present invention;

FIG. 5 is a table setting forth the information associated with each event notification and used by the NMS to determine when an event notification should be announced in accordance with the present invention; and

FIG. 6 illustrates a block diagram of a source server in accordance with the present invention.

### DETAILED DESCRIPTION

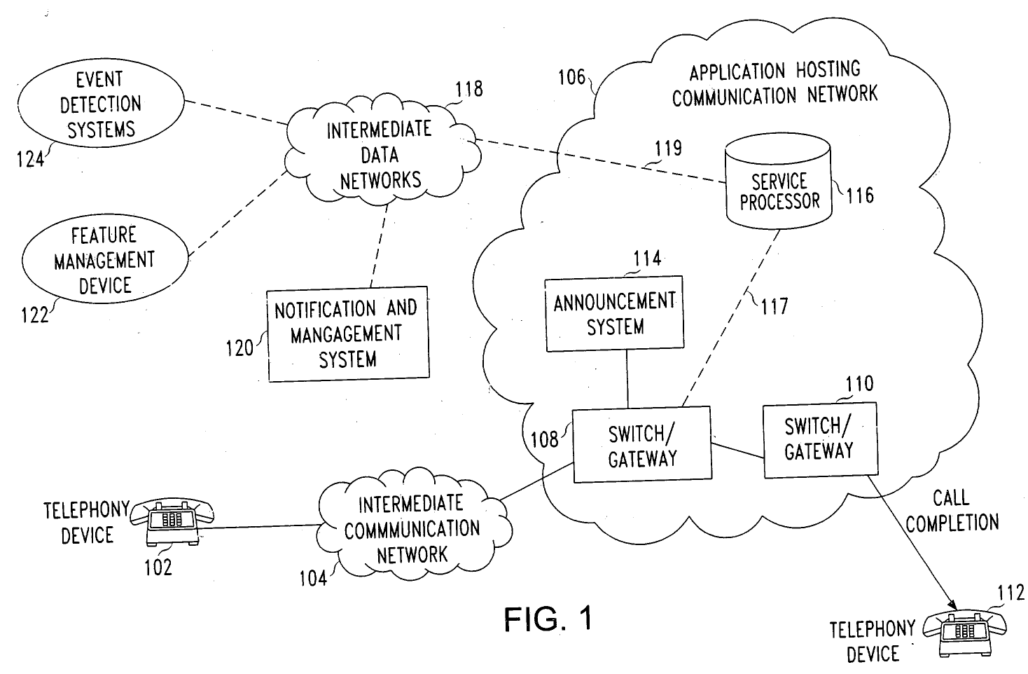

The present invention is directed to a method of providing a caller during call set-up with notification of personal events pertaining to the caller that originate from multiple sources external to the communication network. FIG. 1 illustrates an exemplary network architecture for implementing the method of the present invention. A caller uses a telephony device 102 to make a call to a telephony device 112 associated with a called party. The telephony devices 102, 112 may be, but are not limited to, wired telephones, wireless telephones or a personal computer with telephony capability (e.g., Voice over Internet Protocol (VoIP) software).

The call is received at an intermediate communication network 104. The intermediate communication network 104 may be a Public Switched Telephone Network (PSTN), an Internet Protocol (IP) network, a Time Division Multiplex (TDM) network, Asynchronous Transfer Mode (ATM) network, frame relay network or any other type of communication network capable of carrying telephony communications. In most instances, the call is received by an initial routing device (not shown) such as a central office, router or mobile switch.

The call is then routed to an application-hosting communication network (AHCN) 106. The AHCN 106 may be a Public Switched Telephone Network (PSTN), an Internet Protocol (IP) network, a Time Division Multiplex (TDM) network, Asynchronous Transfer Mode (ATM) network, frame relay network or any other type of communication network capable of carrying telephony communications. It is to be understood by those skilled in the art that the telephony device 102 may be directly connected to the AHCN. In such an instance, the intermediate communication network 104 would not be included in the architecture of FIG. 1.

The AHCN 106 comprises a plurality of switches or gateways depending upon the type of communication network employed of which switches 108 and 110 are exemplary. The AHCN 106 also comprises an announcement system 114 and a service processor 116. The announcement system 114 is an adjunct processor that is capable of playing tones and/or announcements. In an intelligent network, the announcement system is preferably an intelligent peripheral. In a Voice over Internet Protocol (VoIP) network, the announcement system may be a media server. The announcement system may also include a text-to-speech converter (not shown) or be able to receive Dual Tone Mulitfrequency (DTMF) tones from the caller's telephony device 102. The announcement system may also include speech recognition capabilities thereby allowing the caller to speak to the system.

The service processor 116 hosts applications that interwork with a switch 108 in the AHCN 106 to control the telephony connection and a Notification and Management System (NMS) 120 which acquires information about personal events pertaining to the caller and to receive reports regarding which events have been communicated to the caller. The service processor 116 further includes a signaling interface 117 for interacting with the network switches 108, 110 and a data interface 119 for interacting with the NMS 120. In an intelligent network, the service processor 116 may be a Service Control Point (SCP). In a VoIP network, the service processor may be an application server.

The NMS 120 receives event notifications from an Event Detection System (EDS) 124 and provides those event notifications in an appropriate format to the service processor 116. The NMS 120 also allows a caller or user of the service to manage types of events and sources from which notifications are provided to the caller.

The EDS 124 is a collection of systems capable of either directly detecting events or receiving events from other sources, and determining which are appropriate to report to a NMS for a given user. These systems can be fully integrated or exist in a distributed arrangement. The EDS 124 is programmed to report these events to the NMS 120. The types of systems which may be incorporated into the EDS 124 include, but are not limited to voice mail servers, email servers, instant messaging servers, identified (e.g., home) Local Area Networks (LANs) or personal computers, and other networked appliances (e.g., a home security system with motion or other sensors, or an intelligent oven) capable of detecting events such as those used in a Bluetooth™ community.

Each system within the EDS 124 can be dedicated to a single user or used by multiple users. For example, if an email system is affiliated with a particular Internet Service Provider (ISP), such as AT&T Worldnet™, that server may detect events for multiple users of the notification service. However, if the system is affiliated with a networked appliance (e.g., a home security system), that server would only detect events for a single user.

An EDS is programmed to know which events should be reported to a NMS for a given user. In addition to the event, the EDS would also be taught to forward a user ID, authentication information such as a password, and its network address. It is to be understood by those skilled in the art that while the present invention contemplates programming of the EDS as described, other alternatives may be employed. For example, once a user profile has been defined in the Feature Management Device as described below and uploaded to the NMS, the EDS can be programmed to learn what events and related information are appropriate for a given user by retrieving that from the NMS. That retrieval could occur by initiation of the NMS, or by the EDS either on a onetime basis or by querying the NMS whenever the EDS has a candidate event.

A Feature Management Device (FMD) 122 incorporates a user interface which allows a user to manage his or her notification service features. Such management may be maintained in a profile associated with the user. The FMD 122 interacts directly with the NMS 120 and can be used to define those events that the user wishes to receive as will be described in more detail hereinafter. The FMD 122 can be a web server that is accessed by a user via a personal computer that includes browsing software.

The FMD 122 can include a menu of predefined categories from which the user can select sources from which to receive event notifications. Such categories may include home email, business email, voicemail, personal online calendar, such as the type included in Microsoft Outlook, etc. Alternatively, the user can input particular systems or event items which should be considered when providing the user with announcements. The user can also include in his or her profile such parameters as when to refrain from playing a message, priority ratings for particular types of messages and whether a user would like to extend the call interval prior to the start of a call in order to hear more notifications.

A caller can also define new event items. For example, if a user is receiving events from a networked appliance such as a home security system or an intelligent appliance such as an intelligent stove or thermostat, the user might want to receive particular information. In the case of the home security system, the user might want the event to include content about the specific area of the home from which the service is to be accessed when the user places a call. The content may also include information pertaining to the detection of a security breach and whether it resulted in the triggering of an alarm. For such event items, the user may wish to define in his or her profile the type of information that is to be announced, and may alter the priority of the announcement based on the specified information.

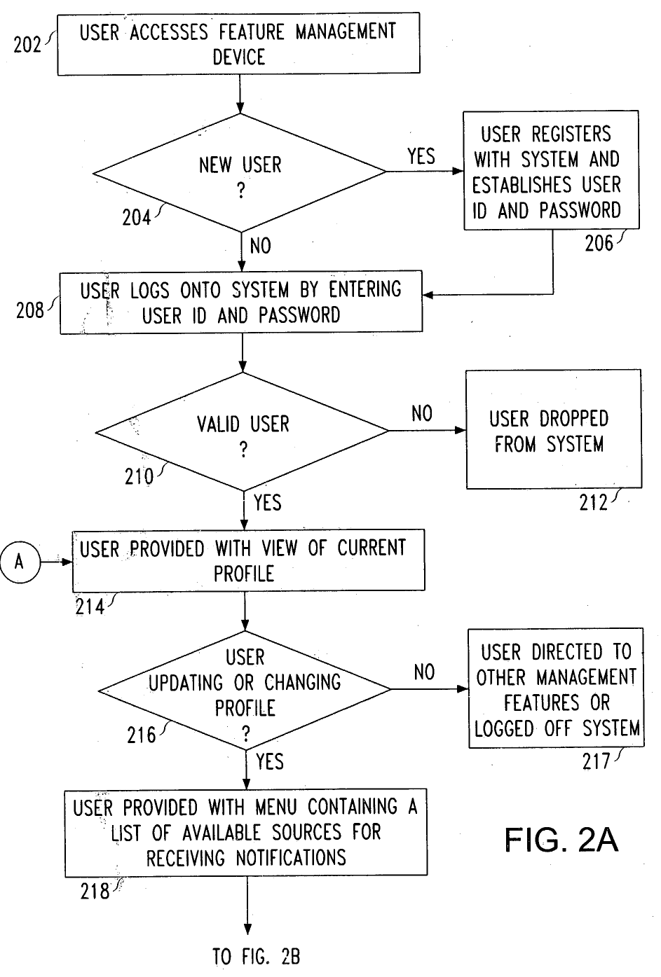

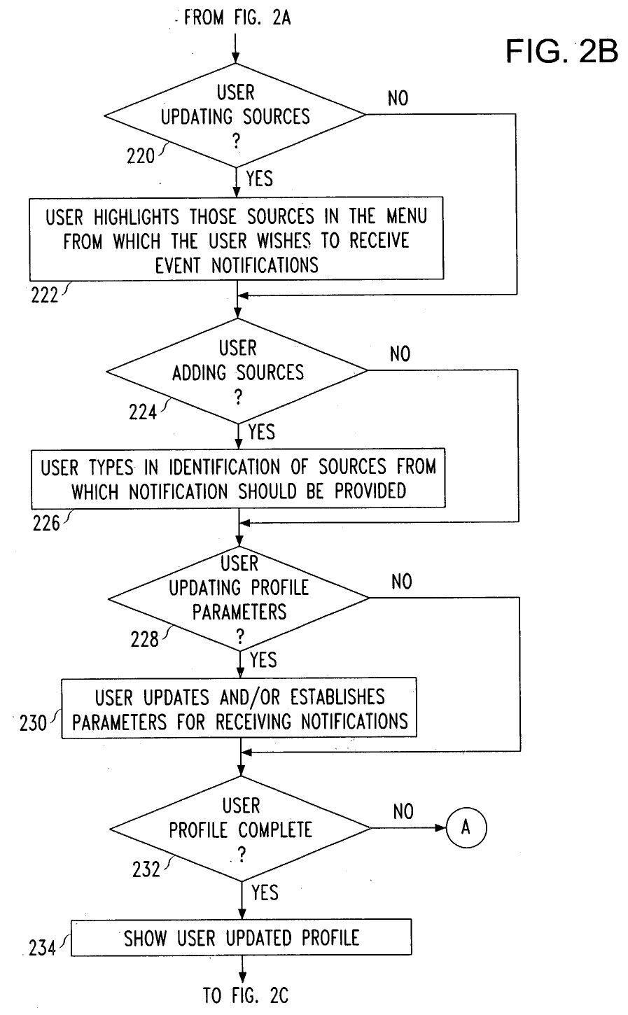

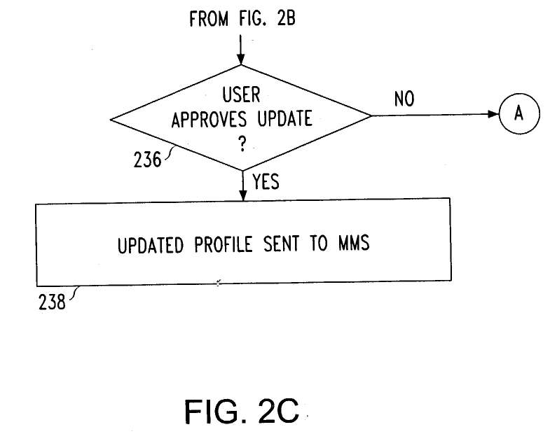

FIGS. 2A-2C are a flow chart that depicts the steps for registering a new user or updating an existing user's profile. A user of the notification service would access the service via the FMD 122 (step 202). Typically the user would use a computer or other web-enabled device to access a web site associated with the service by entering the appropriate Internet Protocol (IP) address (e.g., www.notify.com). Upon accessing the web site, a determination would be made as to whether the user is an existing user or a new user (step 204). If the user if an existing user, the user would log onto the system by entering a userid and password at the appropriate place on the site (step 208).

If the user is new to the service, the user must register with the service (step 206). Registration typically requires entry by the user of personal information such as name, address, telephone number, etc. Particular to this service, the user also includes a listing of telephone numbers and/or IP addresses from which the service is to be accessed when the user places a call. Such listings include home personal listings, business listings, organization listings, school listings, etc. Once the registration is completed and accepted by the service, a userid and password are established for the user and the user is able to log onto the service (step 208).

Next, a determination is made as to whether the user's log in information is valid (step 210). If the information is not valid (i.e., invalid userid and/or password), the user is declined access to the system (step 212). It is to be understood by those skilled in the art that the user may be given multiple opportunities to enter valid log in information. If valid log in information is entered, the user is presented with a screen containing the user's current profile information (step 214). In the case of a new user, the profile information merely contains information extracted from the user's registration information.

Next, a determination is made as to whether the user wishes to update or change his or her profile (step 216). If a user does not wish to update or change his or her profile, the user may be directed to another management feature or may log off the service (step 217). Other management features may include customer service features, bill payment features, etc.

If a user wishes to update or change his or her profile, the user is provided with one or more menus that contain various profile features. One of the menus may include a standard list of available sources or categories of sources (e.g., email, voicemail, etc.) for receiving event notifications (step 218). Such a list may be compiled based on sources selected by an average user. The list may include email servers, voicemail servers, instant messaging servers or popular web sites. A determination is made as to whether a user wishes to update his or her sources (step 220). If a user wishes to update his or her sources, the user can use any conventional method for selecting a source, such as highlighting those sources that should be included on the web page (step 222). In the situation where a category is chosen, more specific information must be supplied by the user such as a specific email address, the email provider or ISP, etc.

Next, a determination is made as to whether the user wishes to add any sources in addition to those contained in the standard list (step 224). For example, there may be web sites or personal calendar software programs from which the user wishes to extract event notifications. In that case, the user types in the identification of those sources that should be added to his or her profile (step 226). Such identification may be established by entering an IP address associated with the web site or the user's computer if the calendar software is resident on the user's computer.

The user typically specifies a password or other authentication information and the user or FMS specifies a user ID of some sort that the EDS must provide to the NMS when reporting an event. The NMS uses the EDS source address, user ID and password to identify and validate the event report. Alternatively, the user can specify to the FMS that events should be accepted from any source that includes a valid user ID and authentication information.

Next, a determination is made as to whether the user wishes to update his profile parameters (step 228). Profile parameters are typically preferences which may be applied to event notifications to determine when and how often a particular notification should be played. These parameters may include adding a priority ranking to notifications, adding the number of times a notification should be played, etc.

The user may also elect to define a maximum amount of time delay to be applied to call set-up so that more notifications can be heard prior to the call being placed. The user may specify in the profile the priority of an event and the number of times notifications should be played, or the user may specify that such information may be received by the NMS as ancillary information from an EDS when the EDS reports an event to the NMS. It is to be understood by those skilled in the art that while the present invention contemplates notifications to be played during call set-up that an alternative embodiment could have the call forwarded to an adjunct processor and suspended for the time period in which announcements are played to the caller.

Next, a determination is made as to whether the user has completed the update of his or her profile (step 232). If the update is not complete, the user is directed back to the original menu for providing updates (step 214). If the user has completed his or her update, the updated profile is presented to the user (step 234). Next a determination is made as to whether the user approves the updated profile (step 236). If the user approves the updated profile, the profile is communicated to the NMS 120 where it is stored (step 238). If the user does not approve the profile, the user is returned to a menu for updating the profile until the user has approved a profile.

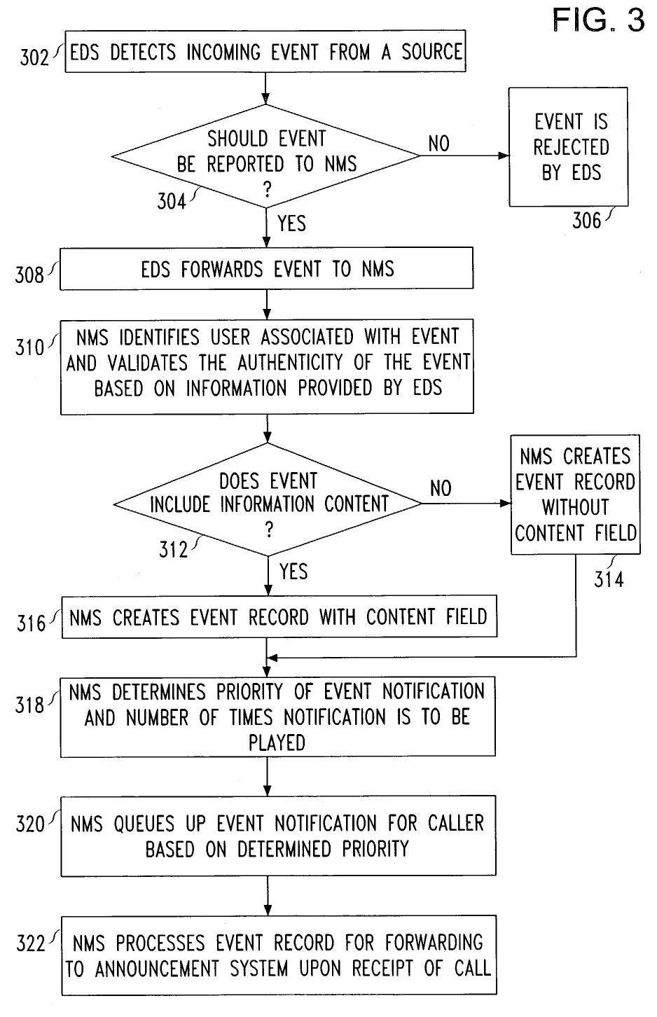

FIGS. 3A and 3B illustrate a flow chart that depicts the steps for detection of an event by the EDS 124. In accordance with the present invention, sources or devices associated with the service (e.g., email servers, instant messaging servers, voice mail servers, etc.) provide the EDS 124 with potential event notifications. Each source is capable of detecting a potential event (e.g., incoming email message or voicemail message).

When an event is detected by a source, the event is transmitted from the server to the EDS 124. It is to be understood by those skilled in the art that the source or device is essentially a dumb device in that the source or device merely notifies the EDS of any incoming event and makes no determination whatsoever as to whether that event is one to be forwarded by the EDS to the NMS. It is to be further understood by those skilled in the art that an alternative embodiment may have the EDS 124 periodically poll the various sources for possible event notifications.

When an event notification is transmitted to the EDS 124 (step 302), the EDS 124 determines whether that event should be reported to a NMS (step 304). If the event is determined not to be reported to the NMS, the EDS reject the event (step 306). If so, the EDS 124 forwards the event to the NMS (step 308), also including a user ID and possibly other information such as password, EDS source address, time and date, priority and/or number of times notification is to be played, and event content formatted in a way acceptable for use by an announcement system, and an obsolescence time and date.

The NMS receives the event report from the EDS, and first identifies which user it belongs to, and validates its authenticity based on the EDS-provided authentication information and/or EDS source address (step 310). Based on a user's profile, certain events might require particular event content, particularly if the event was received from a networked appliance. The NMS determines if the particular event includes event content (step 312). As indicated above, certain sources, such as networked appliances may communicate events for which additional information is required to be communicated to the caller to make the notification more meaningful. Such information could include identification of the source, time of the message, or other ancillary information such as temperature reading, alarm notification, or other information specifically related to the event being communicated. If the event does not include event content, the NMS creates an event record that does not include a content field (step 314). Alternatively, the content field can be left blank.

If the event does include event content, an event record is created which includes a content field (step 316). The NMS creates a record for each event notification. The NMS also determines which notifications are announced to a user during call set-up and what information is conveyed to a user during call set-up.

The record for each event notification includes information such as the source from which the event notification was received, the date of the event, and a description of the event and any event content. The event record may also include an indication of the format of the event information. That content may be formatted in ASCII or XML or other format that the NMS and announcement system can support.

In accordance with the present invention, the NMS determines the priority of the notification by analyzing the user's profile, and based in part on the priority, the number of times that the notification should be played to the user (step 318). It is to be understood by those skilled in the art that any conventional method can be used to determine the priority of each notification and ultimately the ordering of the events for purposes of announcement. For example, a weighted scheme can be used in which each piece of information is assigned a value and then given a weighted factor. For example, the priority and date may be assigned a higher weighted factor than the source or event type. A weighted average would be obtained to determine the order in which events are announced.

An alternative method for determining priority of each notification is to assign each notification an absolute value (e.g., a value between 1 and 100) based on characteristics specified in the user's profile. For example, an email originating from a particular email address (for example a spouse's email address) might be assigned a priority of 90 whereas a different particular email address (e.g., a co-worker's address) might be assigned a priority of 25. Likewise, certain sources may be given a higher priority (e.g., a home security system may be given a priority of 95. The notifications are then ranked by their value and queued for being communicated to the announcement system.

Once the priority and ordering of the notifications has been determined, the NMS 120 queues up the notifications to be played to the user upon call set-up (step 320). In addition, any processing that must be done occurs at this time so that the event record can be forward to the announcement system upon receipt of a call by the caller (step 322). For example, the notifications are preferably audio announcements played to the user. Since most of the received notifications are in text form, these notifications must be converted to speech. In the present invention, the notification would typically include the date and time of the event as well as a brief description of the event. As existing events expire and the NMS 120 receives new events, the NMS 120 revises its queue so that the notifications are ready to be played when the caller places a call.

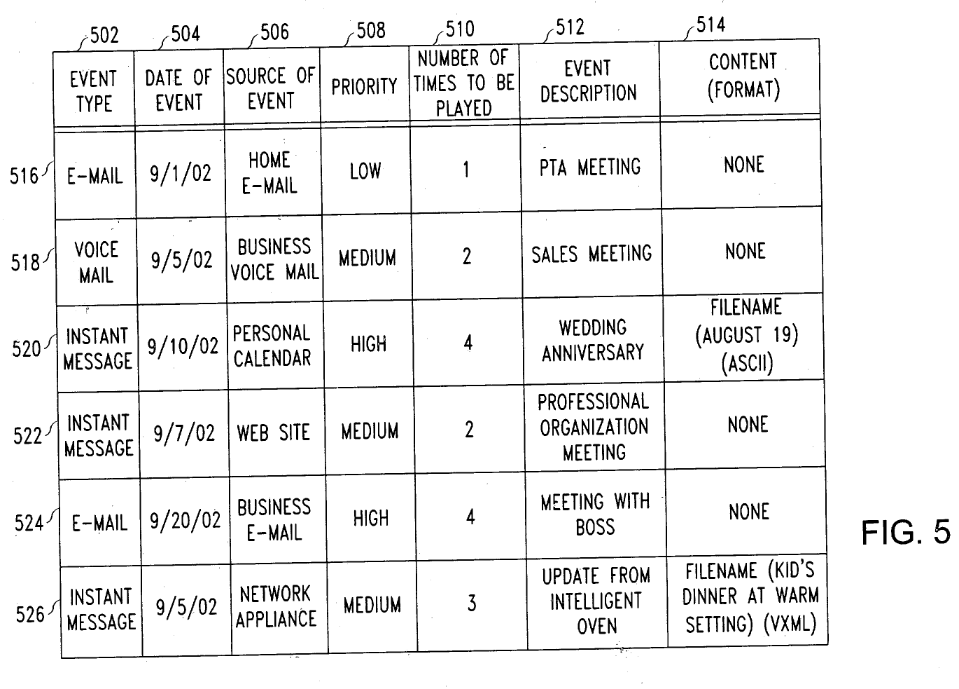

FIG. 5 illustrates an exemplary table that includes event notification records 516-526 for a particular user that are stored in the NMS 120. It is to be understood by those skilled in the art that the arrangement and selection of information to be included in the table is not specific to the present invention and that other arrangements or information could be chosen without departing from the scope and spirit of the present invention. The table of FIG. 5 includes a number of entries which each contain information pertaining to a particular event. For each event, the following information is listed: event type 502, date of event 504, source of event 506, priority 508, number of times to be played 510 and event description 512. The event type column 502 lists the method of communication used to transmit the event. In the present example, email, voice mail and instant messaging have been employed.

The next column contains the date of the event 504. It may be assumed that the date of the event is also the obsolescence date for purposes of discontinuing announcement of that particular event. However, in an alternative embodiment, the event record could include an additional entry (not shown) which would explicitly provide an obsolescence date. The next column 506 indicates the source that originated the event information. Examples of sources include home email accounts, business voice mail accounts, personal calendar software, web sites, business email accounts, and home networked appliance management software. The next column 508 includes the priority of the event notification. Priority can be defined by any number of methods and in the present example is identified as “high”, “medium” and “low”. The priority is determined based on the information provided in the user's profile and other factors such as the date of the event. Note that in the table of FIG. 5, the events are listed in random order and not in the order in which they would be played to the user.

The next column 510 indicates the number of times the announcement is to be played. It is to be understood by those skilled in the art that the number represents the maximum number of times in which the event will be announced since the actual number of times that the announcement will be played will depend in part on the number of calls made by the user, the call set-up time and the number of other notifications to be played.

The next column 512 provides the event description. As indicated, events such as birthdays, anniversaries, parties, meetings, business trips and other special events can be included among the events. As indicated above, networked appliances may also provide information. For example, event record 526 is received from an intelligent oven. Included in the information is content information pertaining to the oven temperature and minutes of cooking.

The final column 514 contains any event content associated with a particular event record. The content field also includes an indication of the format of the content information. In accordance with the present invention, the content may be provided in a file. For example purposes the file is simply identified with a generic filename; however it is to be understood that a more descriptive filename is likely to be used. In the case of event record 520, an instant message may be received by the NMS which includes the date of the wedding anniversary (i.e., August 19) and an indication that the file is in ASCII. Event record 526 would similarly include a file that contains the relevant content (i.e., kids dinner at warm setting) and an indication that the file is in vXML.

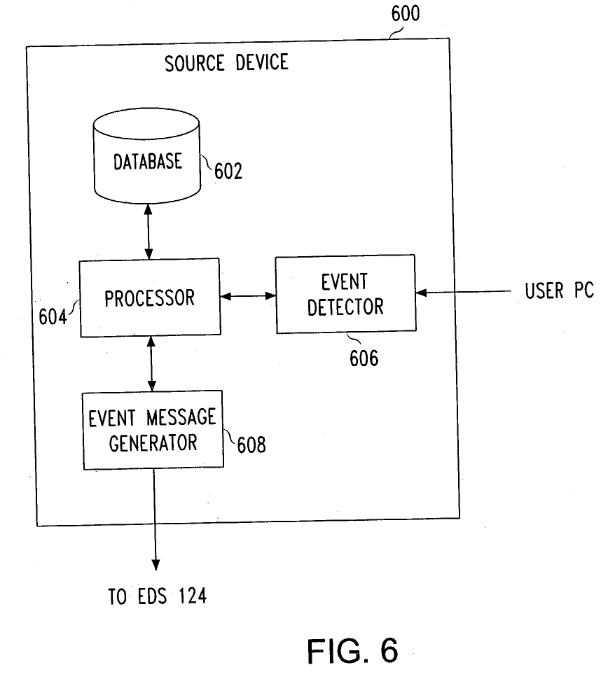

As indicated above, in accordance with the present invention, the EDS 124 receives event notifications when a given source identifies and transmits event information to the EDS 124. FIG. 6 illustrates an exemplary source device 600. The source device may be any type of device from which event notification information can be obtained, such as, but not limited to, an email server, voicemail server, a device that maintains one or more web sites, a networked appliance or a personal computer.

The device 600 includes a database 602 that maintains all of the data associated with the device 600. A processor 604 performs all the computing functions associated with the device 600 and directs data to the database 602 for storage as well as retrieving information from the database 602 as needed.

An event detector 606 detects when the device 600 receives information. Upon detection of an event, the event information is communicated via the processor 604 to an event message generator 608. The event message generator 608 sends a message to its EDS that includes the body of the received message as well as any header information associated with the message. Included in the event message are the intended recipient of the message, the date of the message, an event description and the event source. This information can be included in the body of the message generated, in the header or a combination of both message components. The type of message generated would depend upon the type of device from which the event was detected. For example, an email server may send an email message to the EDS 124 while a web site or personal calendar might send the information in an instant message.

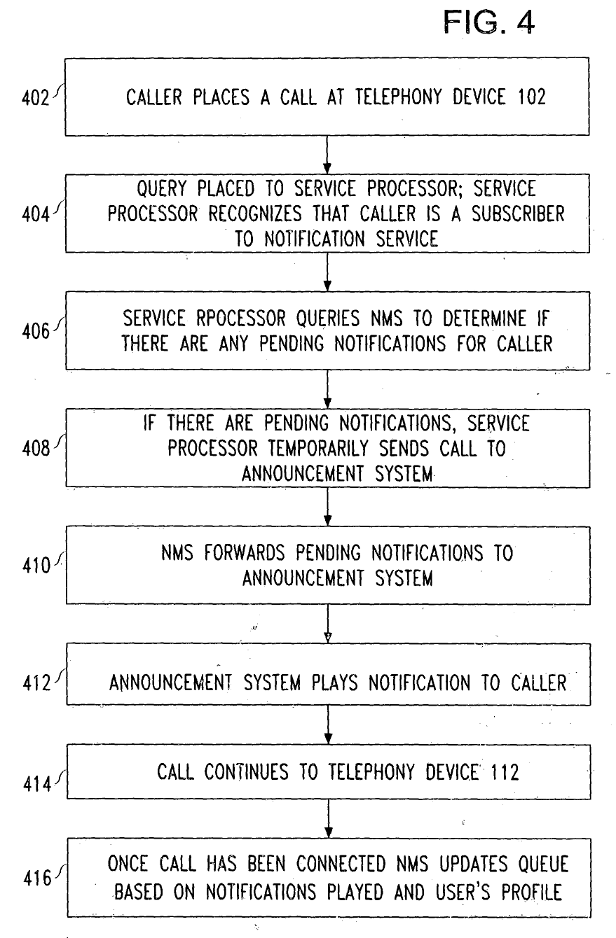

FIG. 4 illustrates the steps for receiving a notification during call set-up in accordance with the present invention with reference to elements from FIG. 1. A caller using telephony device 102 and who is registered with the notification service places a call to a called party (step 402). In some instances, the telephony device 102 from which the call is placed may be used by more than one person (e.g., home telephone). In such an instance a user may have to enter in an identification code prior to placing the call to indicate the election of the service for the call and/or the identity of the caller. Alternatively, the notifications could be provided to all users of the telephony device 102 regardless of the individual's identity.

When the call is received by switch 108, the switch 108 performs a standard query to a service processor 116 for service handling instructions. The service processor 116 recognizes that the call is a subscriber to the notification service (step 404). The service processor 116 then queries the NMS 120 to receive notifications that are to be played to the caller (step 406).

The NMS 120 determines if there are any pending notifications for the caller. If there are pending notifications, the service processor 116 temporarily sends the call to the announcement system 114 (step 408). The NMS 120 forwards the pending notifications to the announcement system 114 via the service processor 116 or directly to the announcement system as identified by the service processor along with caller ID (step 410). More specifically, the NMS provides the announcement system 114 with the event description, any event content and the time and date of the event. The announcement system 114 plays the notifications to the caller during call set-up (step 412). The call is then routed through the network 106 to telephony device 112 (step 414). Once the caller has been connected to the called party, the announcement system stops playing announcements to the caller. The NMS then updates its queue based on the notifications played and the user's profile (step 416).

While the present invention has been described in connection with the illustrated embodiments, it will be appreciated and understood that modifications may be made without departing from the true spirit and scope of the invention. For example, an alternative embodiment of the present invention may require that the call be sent from the service processor to an adjunct processor for a finite amount of time so that the call is suspended. During this finite time, notifications would be played to the caller. In addition, the caller may be able to interact with the network to receive more information relating to a particular event. In some instances the caller may be directed to the source of the event information (e.g., a particular email or voicemail account) or the event record may contain additional information that is then presented to the caller by the announcement system. It is to be understood that the particular embodiments shown and described by way of illustration are in no way intended to be considered limiting. Therefore, references to details of particular embodiments are not intended to limit the scope of the claims, which in themselves recite only those features regarded as essential to the invention.

We claim:

1. A method of notifying a caller of personal event information during the set-up of a call between the caller and a called party comprising the steps of:
receiving a query from a communication network carrying the call from the caller to determine if the caller is a subscriber to a notification service;
if the caller is a subscriber, querying a Notification and Management System (NMS) to determine if the caller has any pending notifications pertaining to personal event information, said pending notifications originating from sources external to the communication network;
if the caller has pending notifications, temporarily sending the call to an announcement system;
playing the pending notifications to the caller during call set-up; and
instructing the communication network to continue to route the call to the called party.

2. The method of claim 1 wherein the step of playing the pending notifications further comprises the steps of:
determining if the called party has answered the call; and
if the called party has answered the call, discontinue playing notifications to the caller.

3. The method of claim 1 wherein the pending notifications include a date for an event.

4. The method of claim 3 wherein the pending notifications includes a time for an event.

5. The method of claim 1 wherein the pending notifications include a brief description of the event.

6. The method of claim 1 wherein at least one of the pending notifications originate from the caller's personal email account.

7. The method of claim 1 wherein at least one of the pending notifications originate from the caller's business email account.

8. The method of claim 1 wherein at least one of the pending notifications originate from the caller's voicemail account.

9. The method of claim 1 wherein at least one of the pending notifications originate from the caller's personal calendar stored in the caller's personal computer.

10. The method of claim 1 wherein at least one of the pending notifications originate from a web site.

11. The method of claim 1 wherein at least one of the pending notifications originate from a networked appliance management software program.

12. The method of claim 1 wherein the communications network is a Public Switched Telephone Network (PSTN).

13. The method of claim 1 wherein the communications network is an Internet Protocol (IP) network.

14. The method of claim 1 wherein the communications network is an Asynchronous Transfer Mode (ATM) network.

15. The method of claim 1 wherein the communications network is a frame relay network.

16. The method of claim 1 wherein the communications network is a cellular network.

17. A method of detecting an event and forwarding an event report for which one or more callers are to receive a notification announcement during call set-up of a call between the caller and a calling party placed over a communication network, the method comprising the steps of:
receiving a message from a source containing information pertaining to a potential event;
matching the message to one or more callers based on a profile associated with each caller;
determining if the message is to be converted into a notification announcement by comparing contents of the message to the caller-defined criteria; and
if the message is to be converted into a notification announcement, transmitting the message to a Notification and Management System (NMS).

18. The method of claim 17 wherein the NMS creates an event record based on the transmitted message and forwards the message to an announcement system to be played to the caller upon the caller's initiation of a call.

19. The method of claim 18 wherein the NMS stores event content and format information and forwards the event content and format information to the announcement system.

20. The method of claim 17 wherein the message is an email message.

21. The method of claim 17 wherein the message is a voicemail message.

22. The method of claim 17 wherein the message is an instant message.

23. The method of claim 17 wherein the source is an email server.

24. The method of claim 17 wherein the source is a voicemail server.

25. The method of claim 17 wherein the source is a web site.

26. The method of claim 17 wherein the source is a software-based personal calendar.

27. The method of claim 17 wherein the source is a a management program for a collection of networked appliances.

28. The method of claim 17 wherein the step of determining if the message is to be converted into a notification announcement by comparing contents of the message to the caller-defined criteria further comprises the steps of:
querying a feature management system to compare the contents of the message to a profile associated with the caller; and
determining if any caller-specified criteria is applicable to the message.

29. The method of claim 28 further comprising the step of:
if the message is to be converted into a notification announcement, forwarding a user ID, password, source address, time and date of message to the NMS.

30. The method of claim 29 wherein further comprising the step of:
authenticating the received message based on validation of the received user ID, password, source address, time and date of message.
